(19) United States
(12) Patent Application Publication
(10) Pub. No.: US 2012/0154762 A1
(43) Pub. Date: Jun. 21, 2012

(54) VIDEO PROJECTOR

(75) Inventors: Yosuke NISHIHATA, Hirakata-shi (JP); Akira MIYANAGA, Daito-shi (JP); Shinya NODA, Neyagawa-shi (JP); Kei YASUKAWA, Daito-shi (JP)

(73) Assignee: Sanyo Electric Co., Ltd., Osaka (JP)

(21) Appl. No.: 13/326,064

(22) Filed: Dec. 14, 2011

(30) Foreign Application Priority Data
Dec. 16, 2010 (JP) 2010-281030

(51) Int. Cl. G03B 21/16

(52) U.S. Cl. 353/58

(57) ABSTRACT

A video projector includes an air inlet that draws in ambient air. An air filter device includes an air filter attached to the air inlet and performs a cleaning operation to remove dust from the air filter in accordance with a cleaning operation sequence. An intake fan draws in the ambient air through the air filter as cooling air for cooling a light valve. A lamp cooling fan sends interior air to a light source lamp as cooling air for cooling the light source lamp. A discharge fan discharges the interior air that has cooled the light source lamp or the light valve. The cleaning operation sequence is configured to perform the cleaning operation during a cooling operation period in which the intake fan is stopped after a projection operation ends while the lamp cooling fan and the discharge fan are operating to cool the light source lamp.

### CROSS-REFERENCE TO RELATED APPLICATIONS

This application is based upon and claims the benefit of priority from prior Japanese Patent Application No. 2010-281030, filed on Dec. 16, 2010, the entire contents of which are incorporated herein by reference.

### BACKGROUND ART

The present invention relates to a video projector, and more particularly, to a video projector that automatically removes dust from an air filter for an air inlet at an appropriate timing to prevent clogging of the air filter.

A conventional video projector, such as a three-chip LCD projector, draws ambient air as cooling air into the projector and directs the cooling air to cooling subjects, such as optical components. In particular, a light source lamp, which is used as a light source, or liquid crystal light valves are cooled with the cooling air.

In such a video projector, an air filter is used to remove dust from the ambient air. Dust accumulates in the air filter as time elapses. As the amount of the accumulated dust increases, the air filter clogs, the amount of intake air decreases, and the cooling effect falls. For this reason, a video projector provided with a cleaning function that uses a brush or the like to automatically clean and remove dust from an air filter at an appropriate timing has been developed.

Japanese Laid-Open Patent Publication No. 2010-75863 describes a projector that uses a timer when operated to remove dust from a filter in fixed intervals. Japanese Laid-Open Patent Publication No. 2010-119941 describes a projector that performs cleaning when the amount of dust on the filter detected by a clogging sensor reaches a threshold or when the total usage time of the projector reaches a predetermined time.

Japanese Laid-Open Patent Publication No. 2008-170808 describes a projector that performs cleaning to remove dust from the air filter after the light source lamp is deactivated to end projection operation and cooling of the light source lamp, light valve, and the like is ended, that is, after stopping a fan that draws in ambient air.

In the projectors of Japanese Laid-Open Patent Publication Nos. 2010-75863 and 2010-119941, the cleaning operation is performed when the projector is operating. In other words, the cleaning operation for removing dust from the air filter is performed in a state in which the fan is operating to draw in ambient air as cooling air and send the cooling air to optical components, or cooling subjects. Thus, the dust removed from the air filter may be scattered again and suspended in the cooling air sent to the optical components when the cleaning operation is being performed.

In the projector of Japanese Laid-Open Patent Publication No. 2008-170808, the cleaning operation for removing dust from the air filter is performed after stopping the fan that draws in ambient air. This prevents the dust removed from the air filter from being scattered again and suspended in the cooling air. However, in a system that includes a plurality of video projectors, for example, the same power supply is often used for all of the projectors, and the power may not be independently cut for each projector. Further, in the projector of Japanese Laid-Open Patent Publication No. 2008-170808, a long time is required from when the projection of an image ends to when the cleaning of the air filter ends. Thus, in this projector, the power may be cut before a cleaning operation sequence for the air filter is completed.

### SUMMARY OF THE INVENTION

One aspect of the present invention is a video projector including an air inlet that draws in ambient air. An air filter device includes an air filter attached to the air inlet. The air filter device performs a cleaning operation to remove dust from the air filter in accordance with a cleaning operation sequence. An intake fan draws in the ambient air through the air filter as cooling air for cooling a light valve. A lamp cooling fan sends interior air to a light source lamp as cooling air for cooling the light source lamp. A discharge fan discharges the interior air that has cooled the light source lamp or the light valve. The cleaning operation sequence is configured to perform the cleaning operation during a cooling operation period in which the intake fan is stopped after a projection operation ends while the lamp cooling fan and the discharge fan are operating to cool the light source lamp.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to a first embodiment as seen from below;

FIG. 2 is a perspective view showing an air filter device removed from a bottom portion of the video projector illustrated in FIG. 1;

FIG. 3 is a block diagram schematically showing the entire structure of the video projector illustrated in FIG. 1;

FIG. 4 is a schematic diagram showing the structure of a cooling system in the video projector illustrated in FIG. 1;

FIG. 5 is a flowchart schematically showing a cleaning operation sequence for the air filter in the video projector illustrated in FIG. 1;

FIG. 6 is a flowchart showing a first cleaning operation subroutine in the cleaning operation sequence illustrated in FIG. 5;

FIG. 7 is a timing chart showing the cleaning operation sequence illustrated in FIG. 1;

FIG. 8 is a flowchart schematically showing a cleaning operation sequence for an air filter in a video projector according to a second embodiment;

FIG. 9 is a flowchart showing a second cleaning operation subroutine in the cleaning operation sequence illustrated in FIG. 8;

FIG. 10 is a flowchart schematically showing a cleaning operation sequence for an air filter in a video projector according to a third embodiment;

FIG. 11 is a flowchart schematically showing a cleaning operation sequence for an air filter in a video projector according to a fourth embodiment;

FIG. 12 is a flowchart schematically showing a cleaning operation sequence for an air filter in a video projector according to a fifth embodiment;

FIG. 13 is a flowchart schematically showing another cleaning operation sequence for the air filter in the video projector according to the fifth embodiment;

FIG. 14 is a flowchart schematically showing a cleaning operation sequence for an air filter in a video projector according to a sixth embodiment;

FIG. 15 is a flowchart schematically showing another cleaning operation sequence for the air filter in the video projector according to the sixth embodiment;

FIG. 16 is a flowchart schematically showing a cleaning operation sequence for an air filter in a video projector according to a seventh embodiment; and

FIG. 17 is a flowchart schematically showing another cleaning operation sequence for the air filter in the video projector according to the seventh embodiment.

### DETAILED DESCRIPTION OF THE INVENTION

### First Embodiment

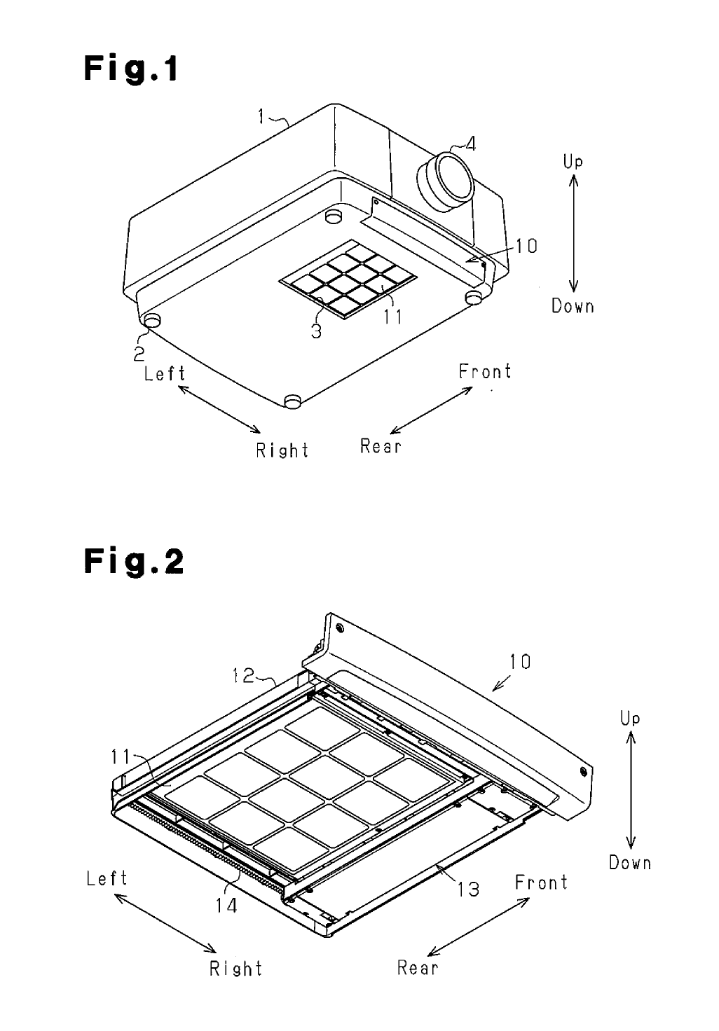

A video projector according to a first embodiment will be described below with reference to FIGS. 1 to 7. In the description hereafter, the frame of reference for the upward, downward, leftward, rightward, frontward, and rearward directions is as viewed in each drawing.

As shown in the perspective view of FIG. 1, a video projector according to the first embodiment, which is a three-chip LCD projector, and includes a box-shaped outer case 1. The outer case 1 includes a bottom portion and a leg 2 arranged at each of the four corners in the bottom portion. An air inlet 3 for drawing in ambient air as cooling air is formed in the bottom portion of the outer case 1. An air filter device 10 is arranged in the air inlet 3.

As shown in FIG. 2, the air filter device 10 is a filter unit including an air filter 11 and equipment for automatically cleaning the air filter 11. The air filter device 10 is attached to a front side of the outer case 1 in a slidable manner and is removable from the outer case 1. A projection lens 4 is arranged at the front side of the outer case 1.

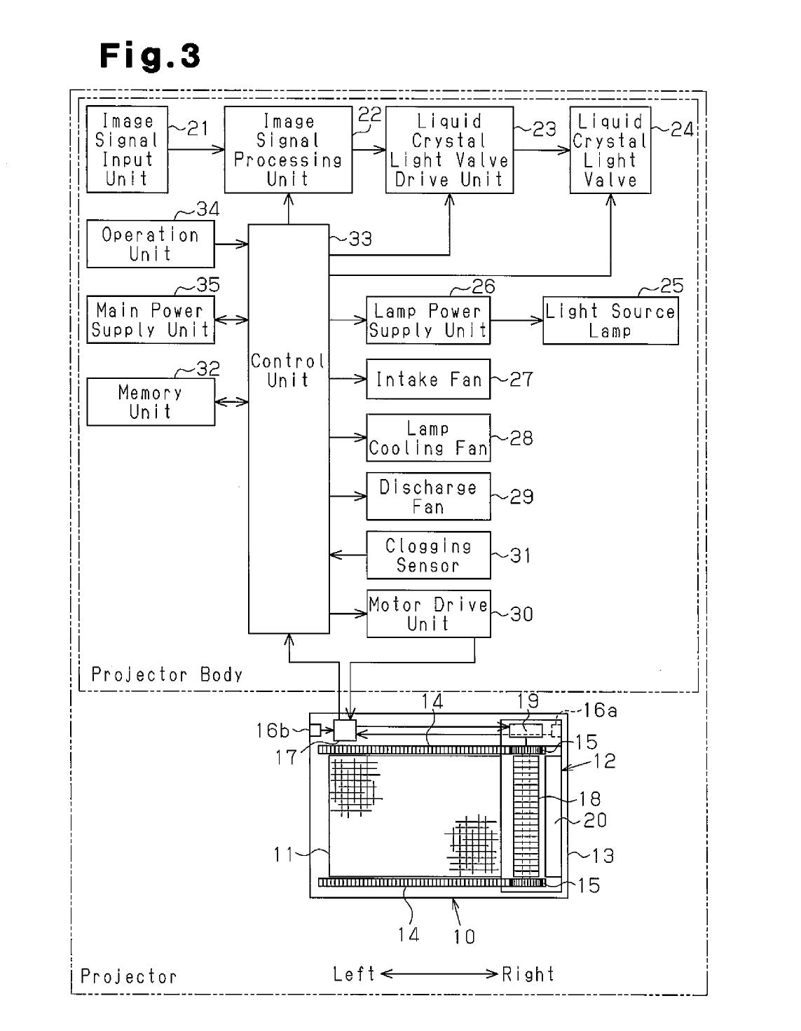

As shown in the perspective view of FIG. 2 and the schematic diagram of FIG. 3, the air filter device 10 includes a housing 12. The air filter 11 and an automatic cleaning unit 13 are arranged on the housing 12. A rack 14 and a pinion 15, which is engaged with the rack 14, are arranged on the housing 12 at each of the front side and rear side of the air filter 11. Further, the air filter device 10 includes a standby position sensor 16a and return position sensor 16b, which serve to detect movement of the automatic cleaning unit 13, and a substrate 17, which electrically connects the automatic cleaning unit 13 to a video projector body.

As shown in FIG. 3, the automatic cleaning unit 13 includes a rotary brush 18, a motor 19, and a dust box 20. The rotary brush 18 removes dust from the air filter 11. The motor 19 drives the pinions 15 and the rotary brush 18. The dust box 20 collects the dust removed by the rotary brush 18.

As shown in FIG. 1, the air filter 11 closes the air inlet 3 in the bottom surface of the outer case 1. The air filter 11 includes a primary air filter (not shown), which is exposed downward, and a secondary air filter (not shown), which is arranged at an inner side of the primary air filter, at a downstream side of the primary air filter.

The video projector includes a controller as shown in the block diagram of FIG. 3. The video projector includes elements related to image generation, such as a image signal input unit 21, a image signal processing unit 22, a liquid crystal light valve drive unit 23, a liquid crystal light valve 24, a light source lamp 25, and a lamp power supply unit 26. Further, the video projector includes elements related to a system for cooling devices in the optical system, such as an intake fan 27, a lamp cooling fan 28, a discharge fan 29, a motor drive unit 30 that drives the motor 19 of the air filter device 10, a clogging sensor 31, and a memory unit 32. The video projector also includes elements related to operation of the entire projector, such as a control unit 33, an operation unit 34, and a main power supply unit 35. These devices will now be described in more detail.

The elements related to image generation will now be described. An image signal is provided from various image reproduction devices to the image signal input unit 21. The image signal input to the image signal input unit 21 is undergoes processing, such as A/D conversion and decoding, and is converted into a digital signal. The digital signal is provided to the image signal processing unit 22.

The image signal processing unit 22 performs normal image processing, such as a scaling, gamma correction, and brightness correction, on the image signal (digital signal). The image signal output from the image signal processing unit 22 is provided to the liquid crystal light valve drive unit 23.

The liquid crystal light valve drive unit 23 converts the image signal from the image signal processing unit 22 into a signal with a configuration for driving liquid crystal cells, which include liquid crystal light valves 24 for green light, red light, and blue light. The liquid crystal light valve drive unit 23 generates a driving pulse for driving the liquid crystal cells for green, red, and blue light.

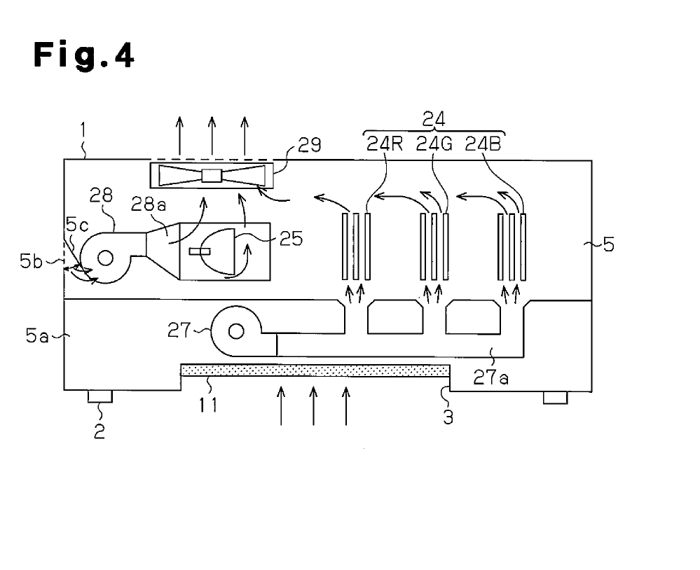

As shown in FIG. 4, the liquid crystal light valves 24 includes a liquid crystal light valve 24R for red light, a liquid crystal light valve 24G for green light, and a liquid crystal light valve 24B for blue light. The liquid crystal light valves 24R, 24G, and 24B, each include a liquid crystal cell, an entrance polarization plate, an exit polarization plate, and the like. In each of the liquid crystal light valves 24R, 24G and 24B, the liquid crystal cell rotates and transmits light from a separation optical system at a rotation angle that is in accordance with the image signal to generate an image. The generated image is projected from the projection lens 4 onto a screen, which is separated by a predetermined distance.

The light source lamp 25 includes a light emission body, or a discharge type lamp, such as a metal halide lamp or an ultrahigh pressure mercury lamp, and emits collimated light from the light emission body with a reflector. The light source lamp 25 becomes hot during use and thus requires cooling. Light generated by the light source lamp 25 is sent to the liquid crystal light valve 24 through an optical system.

The lamp power supply unit 26 converts DC voltage supplied from the main power supply unit 35 into a voltage having a waveform suitable for driving the light source lamp 25. For example, the lamp power supply unit 26 generates voltage having a waveform suitable for activating the light source lamp 25 or generates voltage having a waveform that is suitable for a stable operation of the light source lamp 25.

Elements related to the cooling system for optical system devices will now be described. As shown in FIG. 4, the intake fan 27 draws in ambient air through the air filter 11 in the air inlet 3 and sends the drawn in air to the liquid crystal light valves 24R, 24G and 24E through a duct 27a. The intake fan 27 is arranged in an intake chamber 5a defined in a projector interior 5, which accommodates the liquid crystal light valves 24R, 24G and 243. The air that has cooled the liquid crystal light valves 24 is released in the projector interior 5.

The lamp cooling fan 28 supplies the air in the projector interior 5 to the light source lamp 25 through a duct 28a and cools the light source lamp 25. During the operation of the projector, the projector interior 5 is filled with the air that has cooled the liquid crystal light valves 24R, 24G and 24B, and the lamp cooling fan 28 mainly draws the air in the projector interior 5. As will be described below, the intake fan 27 is stopped during a cleaning operation after the projection operation is stopped. In this case, the ambient air drawn into the projector interior 5 through gaps in the outer case 1 is sent to the light source lamp 25. In this case, there may not be enough ambient air flowing into the projector interior 5. Thus, to draw ambient air directly into the projector interior 5, it is preferable that an opening 5b be formed at an appropriate location, for example, near an air inlet for the lamp cooling fan 28 as shown in FIG. 4. It is also preferable that the opening 5b be provided with a shutter 5c that opens when the pressure of the projector interior 5 becomes negative during the cleaning operation.

The discharge fan 29 discharges air from the projector interior 5. The discharge fan 29 is located in the vicinity of the light source lamp 25 and positively discharges the heated air near the light source lamp 25.

The motor drive unit 30 drives and controls the motor 19 of the air filter device 10 in the automatic cleaning operation of the air filter 11. When removing dust from the air filter 11, the motor drive unit 30 drives the motor 19 to move the automatic cleaning unit 13 to a return position, which is located at the left end as viewed in FIG. 3, while rotating the rotary brush 18. When the automatic cleaning unit 13 is reaches the return position, the motor 19 is driven to return the automatic cleaning unit 13 to its original position, namely, a standby position, based on information sent from the return position sensor 16b. The automatic cleaning unit 13 is moved through the engagement of the pinions 15, which are rotated by the motor 19, and the racks 14. Thus, the rotary brush 18 of the automatic cleaning unit 13 is moved leftward and rightward while rotating during the cleaning operation.

The clogging sensor 31 includes, for example, an air flow sensor. When the air filter 11 clogs, an output voltage of the air flow sensor changes. The control unit 33 compares the change in the output voltage of the air flow sensor with a voltage threshold, which is stored in the memory unit 32, and determines whether or not the air filter 11 is clogged.

The memory unit 32 includes a ROM and a nonvolatile RAM. The memory unit 32 stores, for example, programs for controlling the entire video projector and programs of cleaning operation sequences for controlling the air filter device 10. In addition, the memory unit 32 also stores necessary information for determining the clogging state of the air filter 11, such as a total usage time T of the air filter, a reference set time Ta set to determine the clogging of the air filter, an additional usage time ΔT, an additional set time ΔTa, and a voltage threshold of the clogging sensor 31. The control unit 33 controls the operation of the air filter device 10 in accordance with the programs and information stored in the memory unit 32.

The elements for operating the entire video projector will now be described. The control unit 33 exchanges signals with various units and controls each unit to smoothly operate the entire video projector. When the air filter device 10 is driven, the control unit 33 transmits necessary control signals for the motor drive unit 30 while receiving information from the standby position sensor 16a and the return position sensor 16b.

The operation unit 34 is used by a user to operate the projector and includes devices operated by a user, such as an operation switch, a key, a remote controller, and an external computer. The control unit 33 processes the information input to the operation unit 34 and transmits the operation contents to each unit.

The main power supply unit 35 receives AC power from an external power supply (not shown) and performs processing, such as, voltage conversion, rectification, smoothing, and with an incorporated AC/DC conversion unit to supply stable DC voltage to each unit.

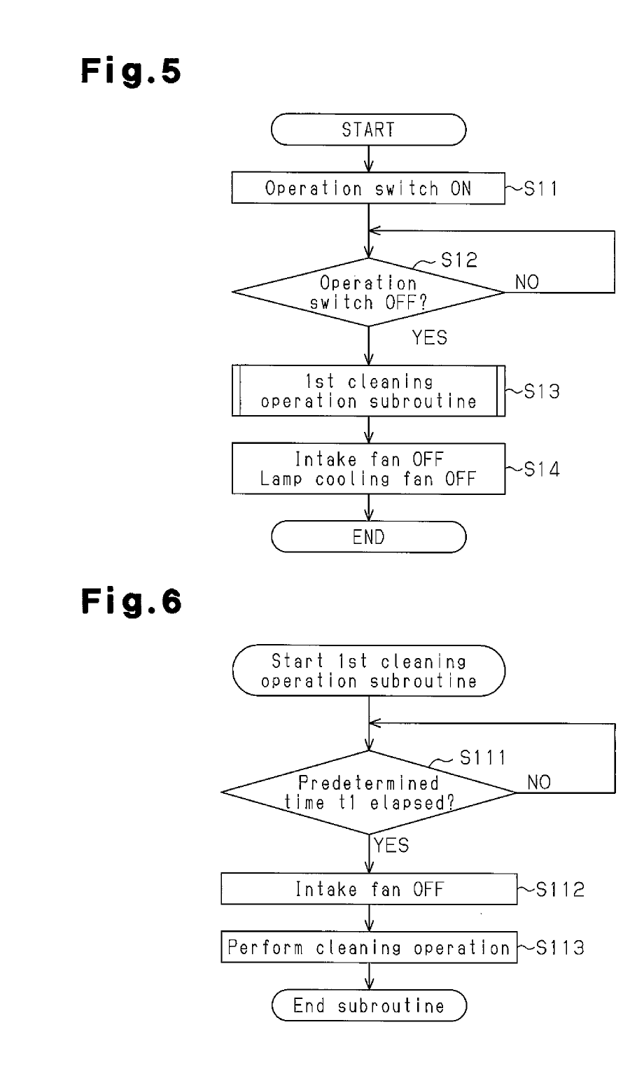

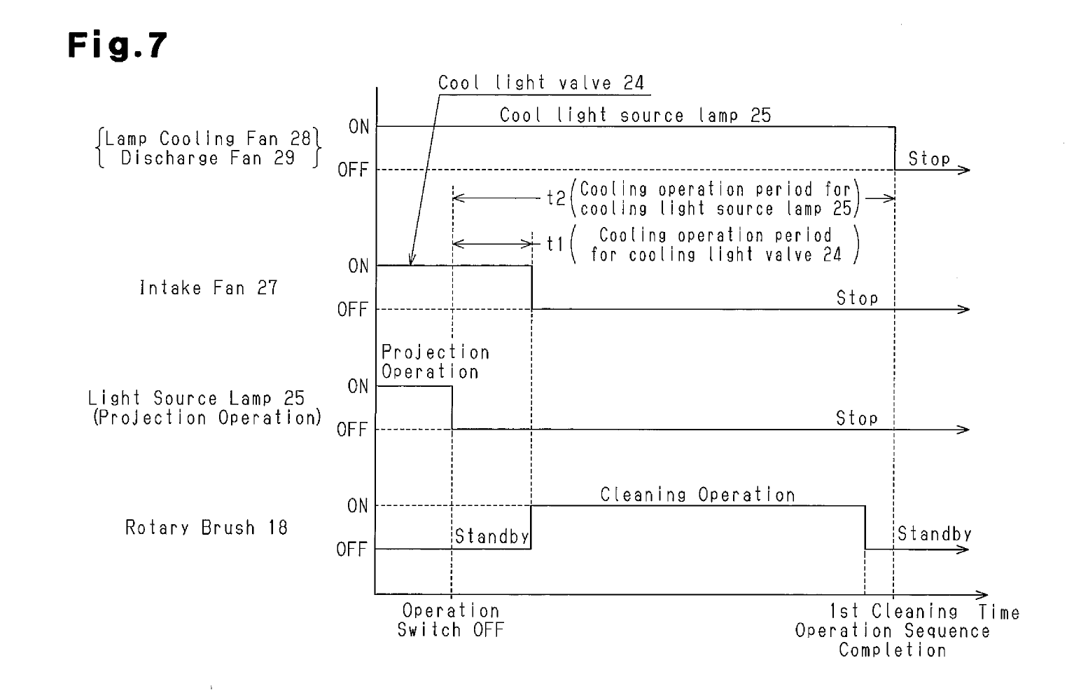

The cleaning operation sequence for the air filter 11 in the video projector according to the first embodiment will now be described with reference to the flowcharts of FIGS. 5 and 6 and timing chart of FIG. 7.

As shown in FIG. 5, in the cleaning operation sequence, when the power supply is connected and an operation switch is turned ON, a projection operation is performed (step S11). Subsequently, the control unit 33 determines whether or not the operation switch is turned OFF after the projection operation is started (step S12). In the video projector of the first embodiment, the operation switch is arranged in the operation unit 34. During the projection operation, the light source lamp 25 is lighted. Further, the intake fan 27, the lamp cooling fan 28, and the discharge fan 29 are operated. This cools the liquid crystal light valves 24R, 24G, and 24B with the ambient air (cooling air) drawn through the air filter 11. The air that has cooled the liquid crystal light valves 24 is released into to the projector interior 5. Then, the light source lamp 25 is cooled with the interior air (cooling air). The interior air that has cooled the light source lamp 25 is discharged from the projector interior 5 by the discharge fan 29.

The control unit 33 starts the first cleaning operation subroutine when determining that the operation switch has been turned OFF (step S13). When the operation switch is turned OFF, the light source lamp 25 goes off and the projection operation stops.

As shown in FIG. 6, the first cleaning operation subroutine determines the procedures for the cleaning operation when the operation switch is turned OFF.

In the first step of the first cleaning operation subroutine, the control unit 33 determines whether or not a predetermined time t1 has elapsed after the operation switch is turned OFF (step S111). When the predetermined time t1 has elapsed (YES in the step S111), the control unit 33 stops the intake fan 27 (step S112) and performs a cleaning operation for removing dust from the air filter 11 (step S113).

As shown in FIG. 7, the cleaning operation sequence of the first embodiment is configured so that the intake fan 27 is stopped after the predetermined time t1 elapses from when the operation switch is turned OFF (i.e., deactivation of the light source lamp 25). Accordingly, the cooling operation for cooling the liquid crystal light valves 24 is performed for the predetermined time t1 even after the operation switch is turned OFF. The predetermined time t1 is approximately 30 seconds, for example. As shown in FIG. 7, moreover, the light source lamp 25 is cooled for a predetermined time t2 after the operation switch is turned OFF to prepares for the next operation. In this manner, during the predetermined time t1, the cooling operation for cooling the liquid crystal light valves 24 and the light source lamp 25 is performed.

As described above, the cleaning operation is performed by mechanically removing dust from the air filter 11 with the rotary brush 18. In the cleaning operation, the rotary brush 18 is moved leftward while rotating along the surface of the air filter 11 and then reversed when reaching the left end of the air filter 11 and returned to its original position. In this manner, the rotary brush 18 is moved leftward and rightward.

As shown in FIG. 7, the cleaning operation sequence of the first embodiment is configured so that the cleaning operation is performed during a cooling operation period in which the intake fan 27 is stopped after the operation switch is turned OFF while the lamp cooling fan 28 and the discharge fan 29 are operating to cool the light source lamp 25. In other words, the cleaning operation is set to end before the cooling operation period ends. For this reason, there is not enough time, and the leftward and rightward movement of the rotary brush 18 is set to a single reciprocation in the first embodiment. During the cleaning operation, the flow of air through the air filter 11 is stopped. This prevents the dust removed from the air filter 11 from being scattered and suspended again in the cooling air in the projector interior 5.

When the cleaning operation is completed, the first cleaning operation subroutine ends. The control unit 33 stops the lamp cooling fan 28 and the discharge fan 29 slightly after the first cleaning operation subroutine ends (step S14). This ends the cleaning operation sequence of the first embodiment.

The video projector according to the first embodiment has the advantages described below.

(1) The cleaning operation for removing dust from the air filter 11 is performed in a state in which the intake fan 27 is stopped. This prevents the dust removed from the air filter 11 from entering the projector interior 5 during the cleaning operation and scattering again in the cooling air.

(2) The cleaning operation is performed during the cooling operation that cools the light source lamp 25. Accordingly, after the projection of an image ends, that is, when the projection operation ends, there is no need to separately set the cleaning operation for the air filter after the cooling operation. Consequently, the cleaning operation of the air filter 11 does not lengthen the processing time after the projection of an image ends.

(3) The liquid crystal light valves 24R, 24G, and 24B are cooled until the cleaning operation starts. As compared with when the cooling of the liquid crystal light valves 24R, 24G, and 24B is stopped immediately after the OFF operation of the operation switch, deterioration of the liquid crystal light valves 24R, 24G, and 24B is suppressed.

### Second Embodiment

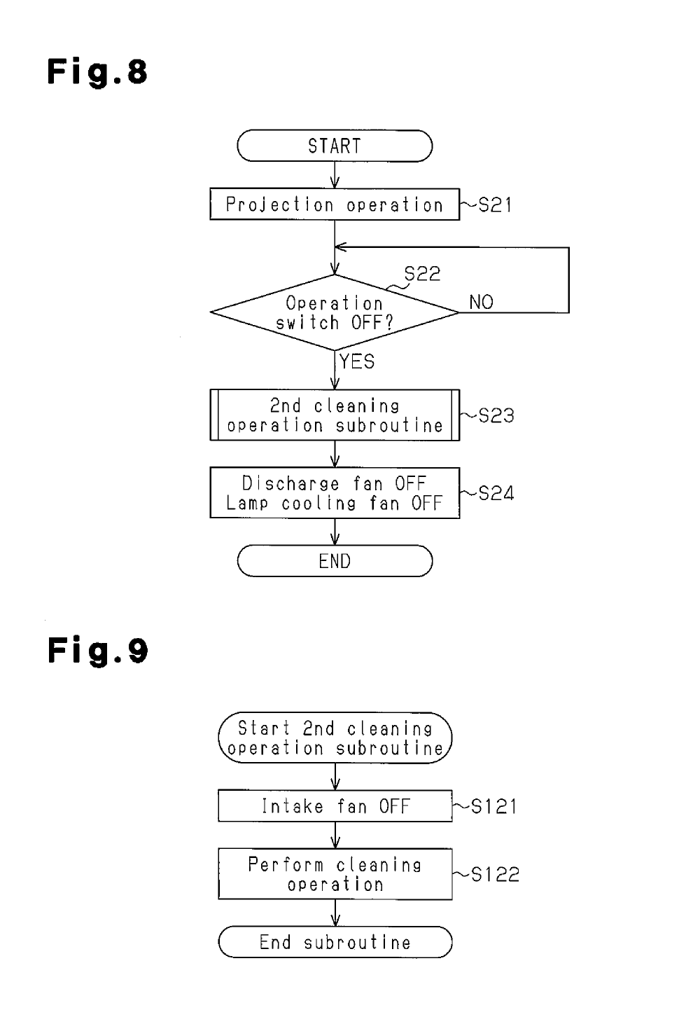

Next, a video projector according to a second embodiment will now be described with reference to FIGS. 8 and 9. In the description hereafter, like or same reference numerals are given to those components that are the same as the corresponding components of the first embodiment. The same applies to the third embodiment.

In the second embodiment, the first cleaning operation subroutine of the first embodiment is changed to a second cleaning operation subroutine. Otherwise, the other parts are the same as the first embodiment.

As shown in FIG. 8, when the operation switch is turned ON to perform a projection operation in the same manner as the first embodiment, a cleaning operation sequence of the second embodiment is started (step S21). A control unit 33 determines whether or not the operation switch is turned OFF after the projection operation starts (step S22). When the operation switch is turned OFF, the control unit 33 deactivates the light source lamp 25 and ends the projection operation. Then, the second cleaning operation subroutine is started (step S23).

The second cleaning operation subroutine differs from the first embodiment in that the intake fan 27 is stopped immediately after the projection operation ends (step S121). In the second embodiment, when the operation switch is turned OFF and the second cleaning operation subroutine is started, the liquid crystal light valves 24 are not cooled. At this point of time, however, the lamp cooling fan 28 and the discharge fan 29 are operated. Thus, the cooling operation for cooling the light source lamp 25 is continuously performed. This gradually cools the liquid crystal light valves 24 without a significant increase in the temperature during the projection operation.

In the second cleaning operation subroutine, the same cleaning operation as that of the first embodiment is performed at the same time as when the intake fan 27 is deactivated (step S122). The second cleaning operation subroutine ends when the cleaning operation ends. In the same manner as the first embodiment, the cleaning operation for cleaning the air filter 11 is set to end before the cooling operation of the light source lamp 25 ends.

In the same manner as in the first embodiment, the control unit 33 stops the lamp cooling fan 28 and the discharge fan 29 slightly after when the cleaning operation for cleaning the air filter 11 ends (step S24) in the cleaning operation sequence of the second embodiment. This ends the cleaning operation sequence. Accordingly, the cleaning operation sequence of the second embodiment differs from the first embodiment in that the intake fan 27 is stopped immediately after the operation switch is turned OFF.

The video projector of the second embodiment has the same advantages as advantages (1) and (2) of the first embodiment.

In this manner, the first and second embodiments both performed the cleaning operation for cleaning the air filter 11 whenever the operation switch is turned OFF.

### Third Embodiment

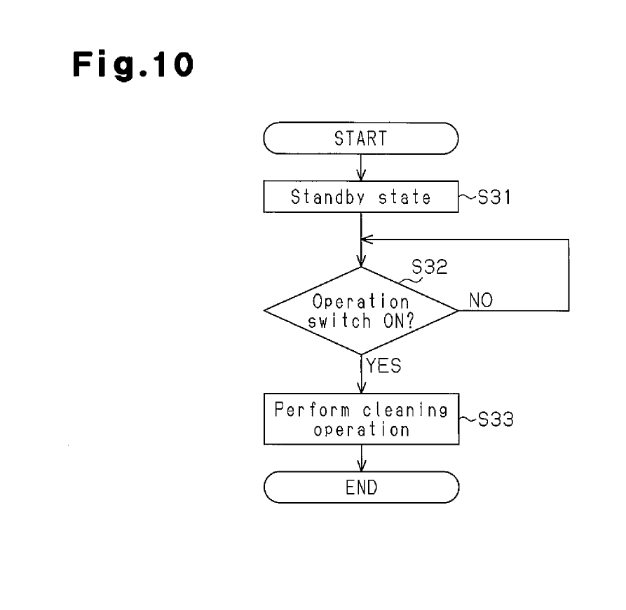

A video projector according to a third embodiment will now be described with reference to FIG. 10. In the third embodiment, the cleaning operation is performed after the projection operation ends like in the video projector of the first and second embodiments. In addition, the cleaning operation is also performed during the projection operation. In other words, in the third embodiment, a cleaning sequence performed when starting the projection operation is added to the cleaning operation sequence of the first or second embodiment.

In the first and second embodiments, the cleaning operation of the air filter 11 is performed after the projection operation is ended and completed during the cooling operation of the light source lamp 25. Thus, there is time for only a single reciprocation of the rotary brush 18. As a result, dust may not be completely removed. Nevertheless, most of the dust is removed. Hence, the operation of the intake fan 27 when the projection operation is started immediately after the cleaning operation ends, a large amount of dust is not scattered again in the cooled air in the projector interior 5. From this viewpoint, in the third embodiment, the cleaning operation is performed while the projection operation is performed. In other words, in the third embodiment, under the assumption that the cleaning operation of the first or second embodiment is performed after the projection operation ends, the air filter 11 is also cleaned when the projection operation is started the next time.

Accordingly, the cleaning operation sequence in the video projector of the third embodiment performs the cleaning operation when the projection operation starts as shown in FIG. 10.

First, when a power supply is connected, the video projector enters a standby state (step S31). Next, the control unit 33 determines whether or not an operation switch has been turned ON (step S32). When the operation switch is turned ON, the control unit 33 activates the light source lamp 25 and drives the intake fan 27, lamp cooling fan 28, and discharge fan 29 to start a projection operation.

When the operation switch is turned ON (YES in step S32), the control unit 33 executes the cleaning operation (step S33). In the cleaning operation, the automatic cleaning unit 13 moves leftward and rightward along the surface of the air filter 11 while rotating the rotary brush 18 as described above.

In this manner, the cleaning operation of the third embodiment is performed when the intake fan 27 is operated. In this state, the cleaning operation that was performed after the previous projection operation ended removed most of the dust from the air filter 11. Thus, it is assumed that the amount of dust that would be scattered again from the air filter 11 into the cooling air in the projector interior 5 would be subtle. Further, when the projection operation starts, the cleaning operation is performed in parallel with the projection operation. Thus, there is sufficient time for cleaning. Accordingly, the leftward and rightward movement of the rotary brush 18 is not limited to a single reciprocation and may be performed a number of times, for example, five times. When the cleaning operation is completed, the cleaning operation sequence of the third embodiment ends.

In addition to the advantages (1) to (3) of the first embodiment, the video projector of the third embodiment has the advantages described below.

(4) In the cleaning operation of the first embodiment, it is difficult to take time for cleaning. Thus, dust may not be completely removed from the air filter 11. Nevertheless, most of the dust is removed from the air filter 11. Thus, even when the cleaning operation is performed when the next projection operation starts, the amount of dust from the air filter 11 scattered again into the cooling air in the projector interior 5 is subtle. In this manner, in the third embodiment, subsequent to the cleaning operation performed after the previous projection operation ended, a cleaning operation is performed when a projection operation is started. This further removes dust from the air filter 11 and prolongs the life of the air filter 11.

### Fourth Embodiment

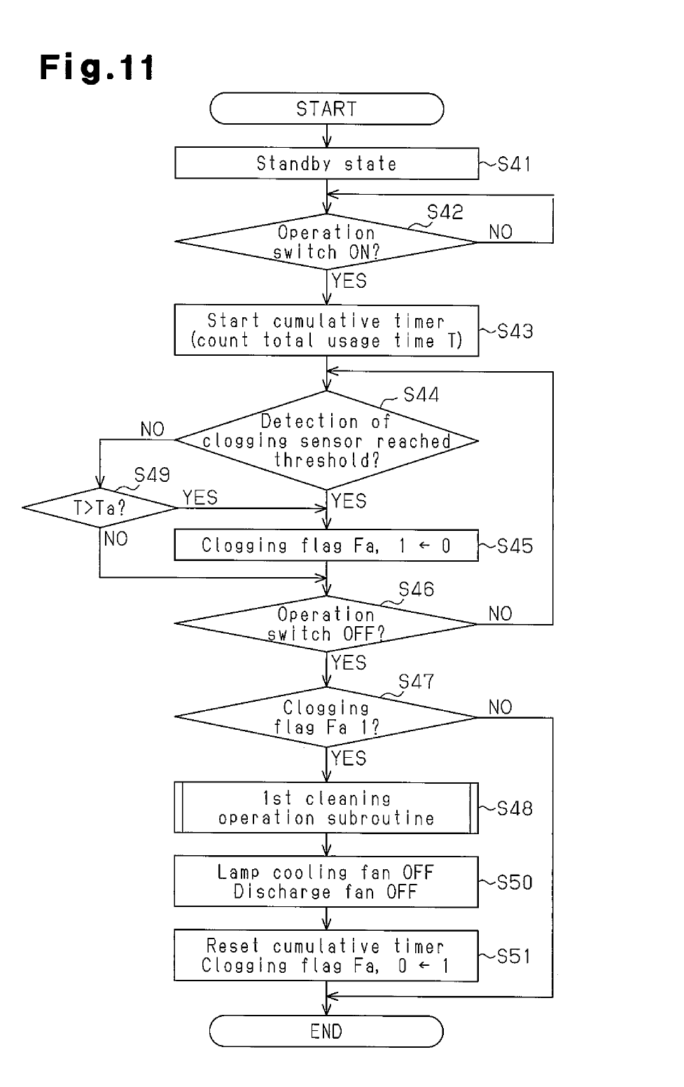

A video projector according to a fourth embodiment will now be described with reference to FIG. 11. In the fourth embodiment, the cleaning operation sequence of the first embodiment is changed. Otherwise, the other parts of the same as the first embodiment.

In the video projector of the first embodiment, the cleaning operation sequence is configured so the cleaning operation is always performed when the projection operation ends. However, the time of the projection operation is not constant and may sometimes be short while being long other time. Thus, if the cleaning operation is performed whenever the projection operation ends, unnecessary cleaning may be performed.

The video projector of the fourth embodiment eliminates unnecessary cleaning and performs a cleaning operation only when necessary. For example, the video projector performs a cleaning operation only when certain conditions are satisfied under which it can be predict that the degree of clogging is high in the air filter 11. A cleaning operation sequence in the video projector of the fourth embodiment will now be described.

As shown in FIG. 11, in the cleaning operation sequence of the fourth embodiment, when the main power supply unit 35 is connected to a power supply such as a commercial power supply, the video projector enters a standby state and waits for the operation switch to be turned ON (step S41). Subsequently, the control unit 33 determines whether or not the operation switch is turned ON (step S42). When the operation switch is turned ON (YES in step S42), the control unit 33 starts measuring the total usage time T of the air filter 11 with a cumulative timer and counts the total usage time T (step S43). The usage time of the air filter 11 indicates the time from when the operation of the intake fan 27 starts to when the operation stops, and the total usage time T of the air filter 11 indicates the cumulative usage time of the air filter 11. The control unit 33 updates the total usage time T stored in the memory unit 32 based on the counted value.

Next, the control unit 33 determines whether the detection of the clogging sensor 31 has reached a threshold (step S44). When the detection of the clogging sensor 31 has reached the threshold (YES in step S44), the control unit 33 sets a clogging flag Fa to 1 in the nonvolatile memory (step S45). Next, the control unit 33 determines whether the operation switch is turned OFF (step S46). If the operation switch is turned OFF (YES in step S46), the control unit 33 determines whether the clogging flag Fa is 1 (step S47). In this case, the clogging flag Fa has been set to 1 in step S45. Thus, the control unit 33 determines that the clogging flag Fa is 1 (YES in step S47) and subsequently starts the first cleaning operation subroutine (step S48).

If the detection of the clogging sensor 31 has not reached the threshold in step S44 (NO in step S44), the control unit 33 determines whether the total usage time T of the air filter 11 has exceeded a predetermined reference set time Ta (step S49). The reference set time Ta indicates the time set for determining the clogging of the air filter 11 and is obtained by predicting the time required for the cleaning of the air filter 11. If the total usage time T exceeds the reference set time Ta (YES in step S49), the control unit 33 updates the clogging flag Fa to 1 (step S45). Then, if the operation switch is turned OFF (YES in step S46), the control unit 33 determines that the clogging flag Fa is 1 (YES in step S47) and starts the first cleaning operation subroutine (step S48).

In the fourth embodiment, the first cleaning operation subroutine shown in FIG. 6 is started to perform the cleaning operation on the air filter 11 when the operation switch is turned OFF in a state in which the detection of the clogging sensor 31 has reached the threshold. The first cleaning operation subroutine is also started to perform the cleaning operation on the air filter 11 when the operation switch is turned OFF in a state in which the total usage time T of the air filter 11 has exceeded the reference set time Ta.

The cleaning operation performed in accordance with the first cleaning operation subroutine is the same as the first embodiment. In other words, as shown in FIG. 7, a cooling operation for cooling the liquid crystal light valves 24R, 24G, and 24B is performed until the predetermined time t1 elapses after the operation switch is turned OFF. Further, a cooling operation for cooling the light source lamp 25 is performed until a predetermined time t2 elapses after the operation switch is turned OFF. The cleaning operation is performed after the predetermined time t1 elapses. The cleaning operation is set to end when the cooling operation for cooling the light source lamp 25 is being performed. Then, the cleaning operation is completed when the first cleaning operation subroutine ends. This stops operating the lamp cooling fan 28 and the discharge fan 29 (step S50). The cumulative timer is reset and the clogging flag Fa is reset to 0 in the nonvolatile memory (step S51) thereby ending the cleaning operation sequence.

If the control unit 33 determines that the total usage time T of the air filter 11 has not exceeded the predetermined reference set time Ta (NO in step S49), the processing proceeds to step S46. Here, even if the operation switch is OFF (YES in step S46), the clogging flag Fa is maintained at 0 (NO in step S47). Thus, the control unit 33 determines that the cleaning operation is not required. Subsequently, the control unit 33 ends the cleaning operation sequence in the state in which the total usage time T is stored in the nonvolatile memory.

In addition to advantages (1) to (3) of the first embodiment, the video projector of the fourth embodiment has the advantages described below.

(5) The cleaning operation sequence is configured so that when a projection operation ends, a cleaning operation is performed when certain conditions are satisfied under which the clogging degree of the air filter 11 can be predicted to be high. Accordingly, a cleaning operation is not performed whenever a projection operation ends, and unnecessary cleaning operations are avoided.

(6) The certain conditions are the total usage time T exceeding the predetermined reference set time Ta after a cleaning operation of the air filter 11 or clogging of the air filter 11 being detected. Accordingly, insufficient cooling of optical components resulting from the clogging of the air filter 11 does not occur as long as the projector is not used under unusual circumstances, such as a projection operation being continuously performed for 24 hours.

(7) The cleaning operation for removing dust from the air filter 11 is not performed during the projection operation. Thus, the dust on the air filter 11 is not scattered again into the cooling air in the projector interior 5.

### Fifth Embodiment

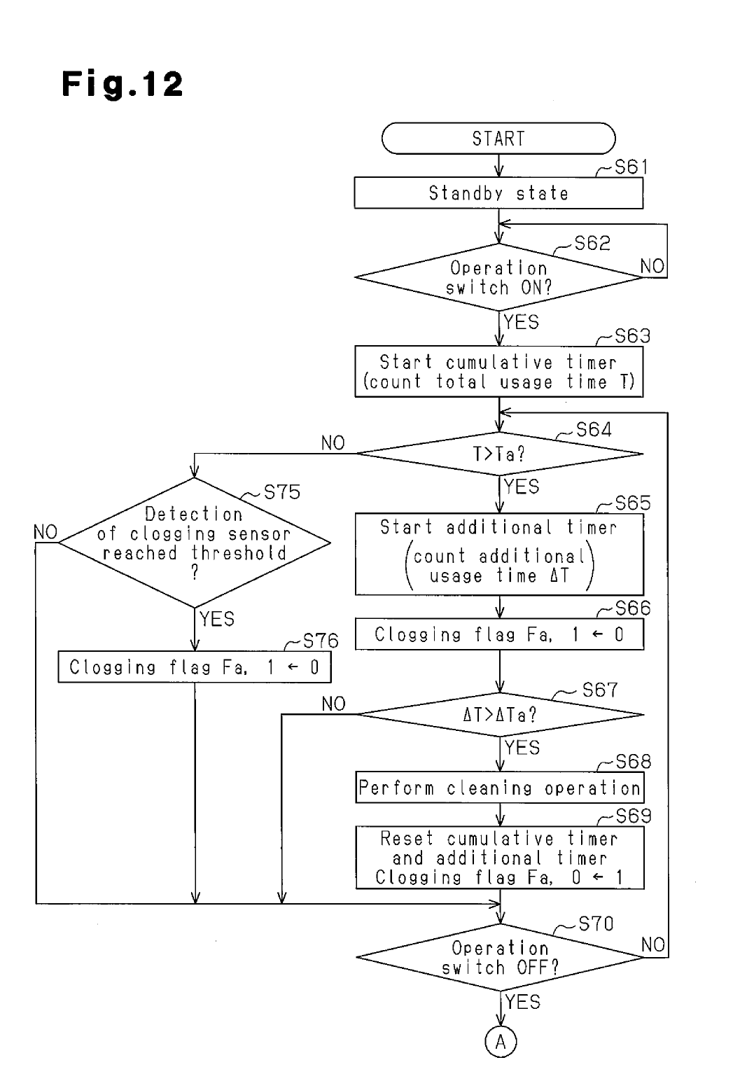

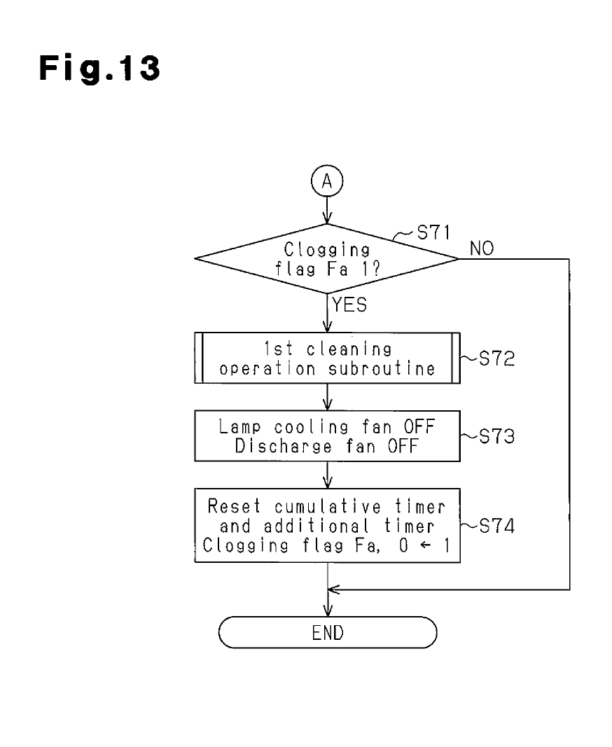

A video projector according to a fifth embodiment will now be described with reference to FIGS. 12 and 13.

In the fifth embodiment, the cleaning operation sequence of the fourth embodiment is changed. Otherwise, the other parts are the same as the fourth embodiment. In the fourth embodiment, the air filter 11 may become clogged when operated for a long period, for example, when a projection operation is continuously performed for 24 hours. The fifth embodiment solves this drawback.

In a cleaning operation sequence of the fifth embodiment, in case a projection operation is performed for a long period of time, a cleaning operation is performed even when a projection operation is not ended if the total usage time T of the air filter 11 exceeds the reference set time Ta during the projection operation.

In the fifth embodiment, continuous use of the air filter 11 beyond the reference set time Ta is referred to as additional use. The time of additional use of the air filter 11 after the reference set time Ta elapses is referred to as an additional usage time ΔT. Further, a tolerated time for additional use of the air filter 11 is referred to as an additional set time ΔTa. In the present example, the reference set time Ta is 100 hours, and the additional usage time ΔT is 30 hours.

A cleaning operation sequence in the video projector of the fifth embodiment will now be described. In the cleaning operation sequence of the fifth embodiment, when the main power supply unit 35 is connected to a power supply such as a commercial power supply, the video projector enters a standby state and waits for the operation switch to be turned ON (step S61) in the same manner as in the fourth embodiment. Then, the control unit 33 determines whether the operation switch has been turned ON (step S62). If the operation switch has been turned ON (YES in step S62), the control unit 33 starts to measure the total usage time T of the air filter 11 with the cumulative timer (step S63). This counts the total usage time T with the cumulative timer, and the total usage time T stored in a memory unit 32 is updated. The above steps conform to steps S41 to S43 of the fourth embodiment.

Next, the control unit 33 determines whether the total usage time T of the air filter 11 has exceeded the reference set time Ta (step S64). If the total usage time T has exceeded the reference set time Ta (YES in step S64), the control unit 33 activates an additional timer and starts to measure the additional usage time ΔT (step S65). The control unit 33 stores a count value of the additional timer in the nonvolatile memory of the memory unit 32. Further, the control unit 33 sets the clogging flag Fa to 1 in the nonvolatile memory (step S66). Subsequently, the control unit 33 determines whether the additional usage time ΔT exceeds the additional set time ΔTa (step S67). If the additional usage time ΔT exceeds the additional set time ΔTa (YES in step S67), the control unit 33 determines that the air filter 11 needs to be cleaned and starts the cleaning operation (step S68).

Since the cleaning operation of step S68 is urgently required, the cleaning operation is performed in a state in which the projection operation is being continuously performed. After the cleaning operation is performed, the control unit 33 resets the cumulative timer for measuring the total usage time T of the air filter 11 and the additional timer for measuring the additional usage time ΔT and resets the clogging flag Fa of the nonvolatile memory to 0 (step S69). In this case, the cumulative timer remains activated after the reset. In other words, the total usage time T is newly counted immediately after the reset. In this manner, the counting of the total usage time T is newly started so that the additional timer is stopped.

In this manner, in the fifth embodiment, the cleaning operation of the air filter 11 is performed regardless of whether the projection operation is being performed during long-term use if the total usage time T of the air filter 11 exceeds the reference set time Ta and the subsequent additional usage time ΔT of the air filter 11 exceeds the additional set time ΔTa. This prevents clogging of the air filter 11. When the projection operation ends immediately after the cleaning operation ends (YES in step S70), the clogging flag Fe is 0 (NO in step S71). Thus, the control unit 33 determines that the cleaning operation is no longer necessary and ends the cleaning operation sequence (NO in step S71→end). On the contrary, if the projection operation is not ended and continuously performed (NO in step S70), the control unit 33 returns to step S64 and continuously performs the projection operation.

As a result of the determination in step S64, if the total usage time T exceeds the reference set time Ta (YES in step S64) and the additional usage time ΔT does not exceed the additional set time ΔTa (NO in step S67), the control unit 33 skips steps S68 and S69 and determines whether the operation switch is turned OFF (step S70). If the operation switch is turned OFF (YES in step S70), the control unit 33 determines whether the clogging flag Fa is 1 (step S71). In this case, the clogging flag Fa remain set to 1 from step S66. Accordingly, the control unit 33 determines that the air filter 11 needs to be cleaned (YES in step S71) and starts the first cleaning operation subroutine (step S72). In the fifth embodiment, when the projection operation ends before the additional usage time ΔT exceeds the additional set time ΔTa but the total usage time T exceeds the reference set time Ta, the first cleaning operation subroutine is started in the same manner as in the case in which the total usage time T exceeds the reference set time Ta in the fourth embodiment.

In the first cleaning operation subroutine, the cleaning operation is performed in accordance with the procedures illustrated in FIG. 6 of the first embodiment. When the cleaning operation is completed, the first cleaning operation subroutine is ended.

When the first cleaning operation subroutine ends, the lamp cooling fan 28 and discharge fan 29 are stopped (step S73). Then, the control unit 33 resets the cumulative timer, which measures the total usage time T of the air filter 11, and the additional timer, which measures the additional usage time ΔT. Further, the clogging flag Fa of the nonvolatile memory is reset to zero (step S74), and the cleaning operation sequence is ended.

In step S71, the control unit 33 determines that the execution of the first cleaning operation subroutine is unnecessary if the clogging flag Fa is 0. A negative determination in step S71 is made when the clogging flag Fa is reset to be 0 in step S69 and when a negative determination is made in step S75, which will be described later. If a negative determination is made in step S71, the cleaning operation sequence is ended in the state in which the total usage time T is stored in the nonvolatile memory.

If the total usage time T of the air filter 11 does not exceed the reference set time Ta at step S64 (NO in step S64), the control unit 33 determines whether the detection of the clogging sensor 31 reaches the threshold (step S75). If the detection of the clogging sensor 31 reaches the threshold (YES in step S75), the control unit 33 sets the clogging flag Fa of the nonvolatile memory to 1 (step S76) and determines whether the operation switch is turned OFF (step S70). If the detection of the clogging sensor 31 does not reach the threshold (NO in step S75), the control unit 33 does not perform any processing but determines whether the operation switch is turned OFF (step S70). The procedures from step S70 to the end of the cleaning operation sequence is as described above. These procedures conform to the procedures from step S46 to the end of the cleaning operation sequence in the fourth embodiment.

The operation of the cleaning operation sequence in the fifth embodiment will now be described.

First, the cleaning operation (step S68) is performed during the projection operation if the total usage time T of the air filter 11 exceeds the reference set time Ta and the additional usage time ΔT of the air filter 11 then exceeds the additional set time ΔTa while the projection operation is being continuously performed (YES in step S67).

The cleaning operation (step S72) is performed when the operation switch is turned OFF if the total usage time T exceeds the reference set time Ta but the additional usage time ΔT does not exceed the additional set time ΔTa (NO in step S67). Further, the cleaning operation (step S72) is also performed if the operation switch is turned OFF when the total usage time T does not exceed the reference set time Ta but the detection of the clogging sensor 31 reaches the threshold (YES in step S75).

After the operation switch is turned OFF, the cleaning operation (step S72) is not performed and the cleaning operation sequence is ended if the total usage time T does not exceed the reference set time Ta and the detection of the clogging sensor 31 does not reach the threshold (NO in step S75). If the cleaning operation (step S68) is performed during the projection operation, similarly, the cleaning operation (step S72) is not performed after the operation switch is turned OFF and the cleaning operation sequence is ended.

In addition to advantages (1) to (3) of the first embodiment and advantages (5) and (6) in the fourth embodiment, the video projector of the fifth embodiment has the advantages described below.

(8) if the total usage time T of the air filter 11 exceeds the predetermined reference set time Ta during the projection operation and the subsequent additional usage time ΔT exceeds the predetermined additional set time ΔTa, the cleaning operation for removing dust from the air filter 11 is also performed during the projection operation. Accordingly, the cleaning operation is properly performed when the projection operation may be performed continuously for 24 hours or when the projection operation is basically performed continuously for 24 hours. This prevents clogging of the air filter 11.

### Sixth Embodiment

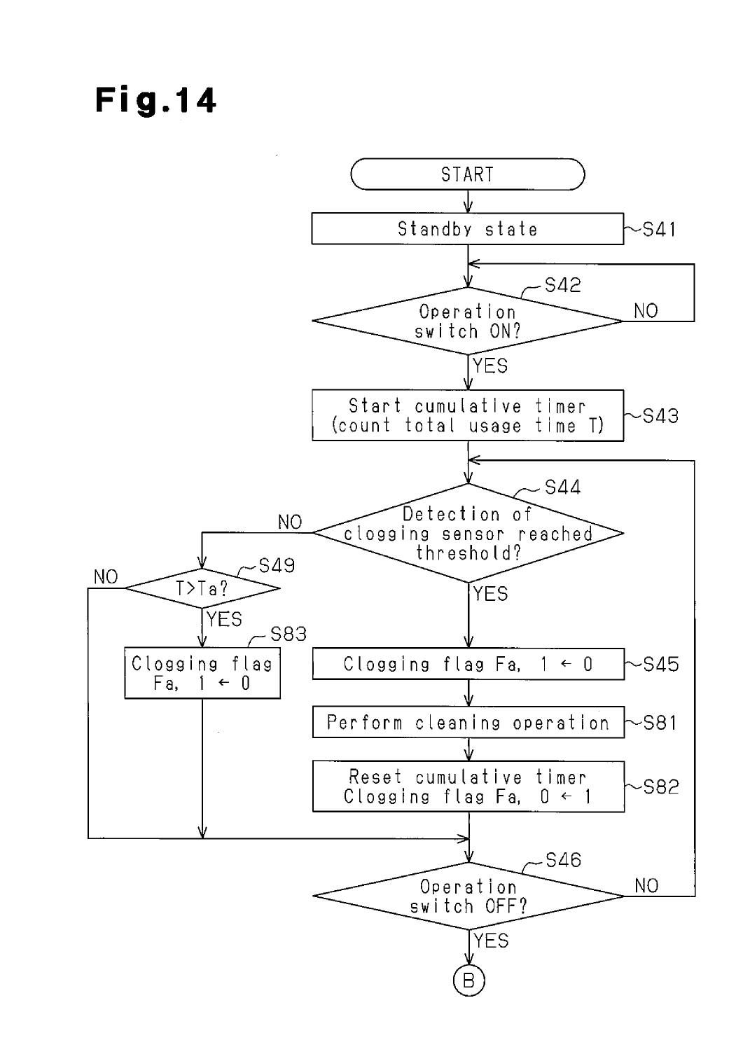

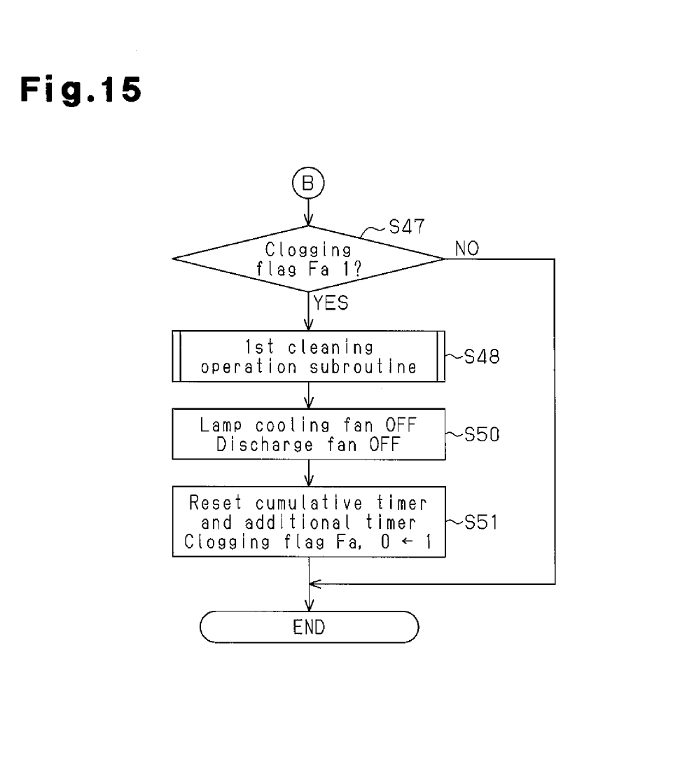

A video projector according to a sixth embodiment will now be described with reference to FIGS. 14 and 15.

In the sixth embodiment, a cleaning operation is performed only if a certain condition is satisfied when the projection operation is satisfied in the same manner as in the fourth embodiment. The sixth embodiment is for a special application in which the projection operation is performed continuously for 24 hours in the same manner as in the fifth embodiment. Further, the cleaning operation sequence of the sixth embodiment is obtained by partially changing the cleaning operation sequence of the fourth embodiment.

More specifically, in the fourth embodiment, if the detection of the clogging sensor 31 reaches the threshold during the projection operation, the cleaning operation (step S48 in FIG. 11) is performed after the projection operation ends. In the sixth embodiment, the cleaning operation is immediately performed if the detection of the clogging sensor 31 reaches the threshold during the projection operation. The differences of the cleaning operation sequence in the sixth embodiment from the fourth embodiment will now be described. Steps having the same contents as the corresponding steps in the fourth embodiment are given the same step numbers and will not be described below in detail.

As shown in FIG. 14, the cleaning operation sequence of the sixth embodiment is obtained by adding steps S81 to S83 to the cleaning operation sequence (see FIG. 11) in the fourth embodiment and the other steps are not changed.

In the sixth embodiment, when the operation switch is turned ON (step S42) in a standby state (step S41), a cumulative timer is activated (step S43) in the same manner as in the fourth embodiment. Then, the control unit 33 determines whether the detection of the clogging sensor 31 has reached the threshold (step S44). If the detection of the clogging sensor 31 reaches the threshold (YES in step S44), the control unit 33 sets the clogging flag Fa to 1 (step S45) and immediately performs the cleaning operation without checking the other conditions (step S81). After the cleaning operation is completed, the control unit 33 resets the cumulative timer and resets the clogging flag Fa of the nonvolatile memory to 0 (step S82). In this case, the cumulative timer continues to operate even after the resetting. More specifically, the total usage time T is newly counted immediately after the resetting. Even if the projection operation ends immediately after the cleaning operation (step S81) ends (YES in step S46), the control unit 33 ends the cleaning operation sequence because the clogging flag Fa is zero (NO in step S47→end). If the projection operation is not ended and continuously performed (NO in step S46), the control unit 33 returns to step 44 and continuously performs the projection operation. The processing from step S46 (steps S47 to S51) are the same as those of the fourth embodiment.

If the detection of the clogging sensor 31 does not reach the threshold in step S44 (NO in step S44), the control unit 33 determines whether the total usage time T of the air filter 11 has exceeded a reference set time Ta in the same manner as in the fourth embodiment (step S49). If the total usage time T exceeds the reference set time Ta (YES in step S49), the control unit 33 sets the clogging flag Fa to 1 (step S83) and determines whether the operation switch is OFF (step S46). The processing flow conforms to the flow from step S49 (YES) to step S45 and then step S46.

In addition to the advantages (1) to (3) in the first embodiment and the advantage (5) in the fourth embodiment, the video projector of the sixth embodiment has the advantages described below.

(9) In the cleaning operation sequence of the sixth embodiment, when the projection operation ends, the cleaning operation is performed only if the total usage time T subsequent to the cleaning operation of the air filter 11 exceeds the predetermined reference set time Ta. In this structure, it is not necessary to perform the cleaning operation whenever the projection operation ends and unnecessary cleaning operations are avoided.

(10) When clogging of the air filter 11 is detected during the projection operation, the cleaning operation is performed without waiting for the projection operation to end. Accordingly, even when the video projector is operated for a long period of time, for example, when the projection operation is performed continuously for 24 hours, clogging of the air filter 11 is prevented.

### Seventh Embodiment

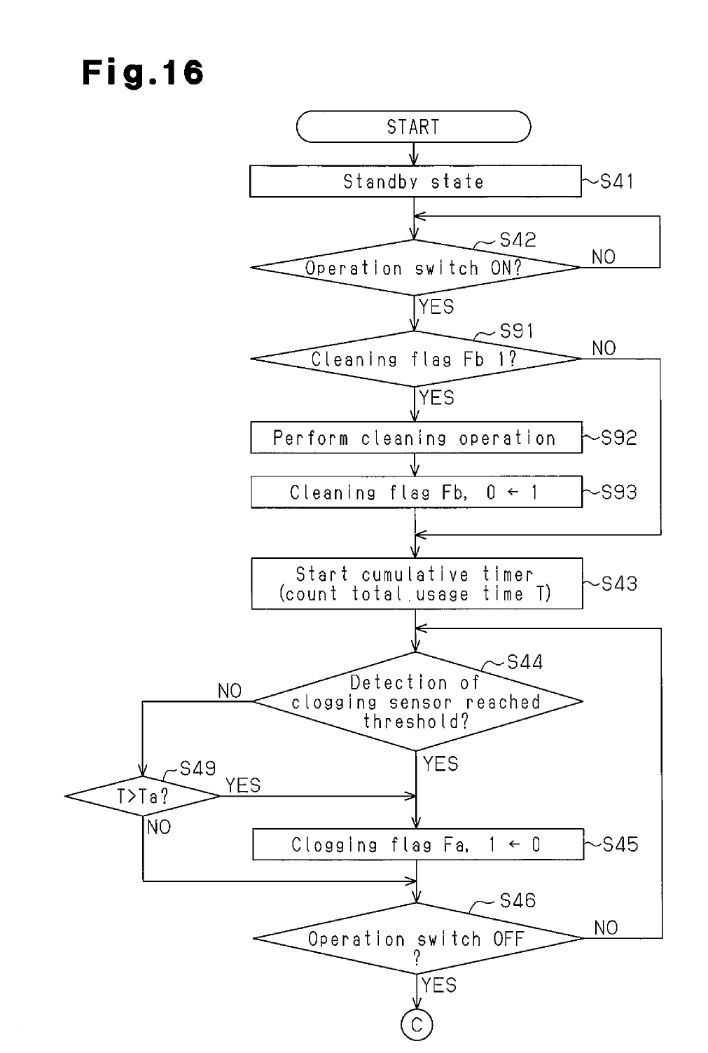

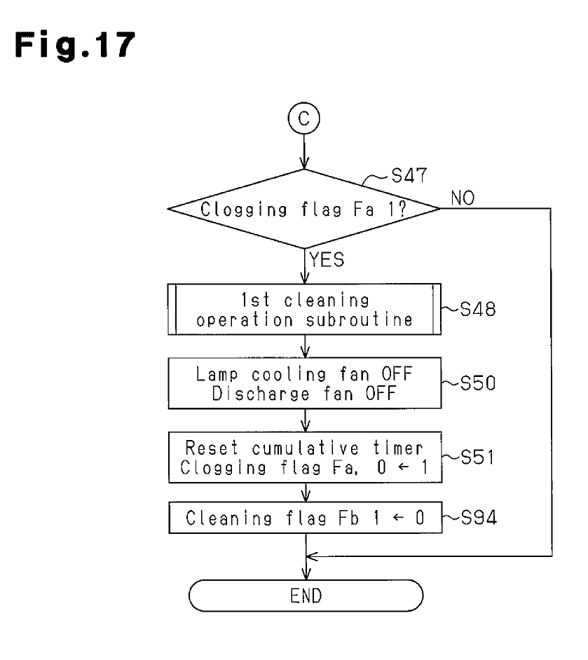

A video projector according to a seventh embodiment will now be described with reference to FIGS. 16 and 17.

In the seventh embodiment, a cleaning operation is performed only if a certain condition is satisfied when a projection operation is ended in the same manner as in the fourth embodiment. After a cleaning operation is performed, when the video projector is started the next time, another cleaning operation is performed. The cleaning operation sequence of the seventh embodiment is obtained by partially changing the cleaning operation sequence of the fourth embodiment.

In the fourth embodiment, a cleaning operation is not performed when a projection operation starts. In the seventh embodiment, after a cleaning operation is performed, another cleaning operation is performed in the next projection operation to prolong the life of an air filter 11. In this respect, the seventh embodiment is similar to the third embodiment.

The seventh embodiment differs from the fourth embodiment in that the step of performing cleaning when a projection operation starts is added to the cleaning operation sequence of the fourth embodiment. The differences of the cleaning operation sequence in the seventh embodiment from the fourth embodiment will now be described. Steps having the same contents as the corresponding steps in the fourth embodiment are given the same step numbers and will not be described below in detail.

As shown in FIGS. 16 and 17, the cleaning operation sequence in the seventh embodiment is obtained by adding steps S91 to S94 to the cleaning operation sequence of the fourth embodiment (see FIG. 11).

In the seventh embodiment, in a standby state (step S41), when the operation switch is turned ON (YES in step S42), the control unit 33 determines whether a cleaning flag Fb is 1 before starting operation of the cumulative timer (step S91). If a cleaning operation was not performed when the previous projection operation ended, the cleaning flag Fb is set to zero (NO in step S47→end). If the cleaning operation was performed when the previous projection operation ended, the cleaning flag Fb is set to 1 (step S94). If the cleaning operation was performed when the previous projection operation ended, that is, when the cleaning flag Fb is 1 (YES in step S91), the cleaning operation is executed during the projection operation (step S92). When the cleaning operation is completed, the cleaning flag is set to 0 (step S93).

If the cleaning operation was not performed when the previous projection operation ended, that is, when the cleaning flag Fb is maintained at 0 (NO in step S91), a cleaning operation is not performed during the projection operation. In this case, the control unit 33 proceeds to step S43 (NO in step S91→step S43). If the cleaning operation was not performed when the previous projection operation ended, the cleaning operation is not performed when the next projection operation starts.

The processing performed after the cumulative timer starts to operate (step S43) is the same as that in the fourth embodiment. In other words, when an operation switch is turned OFF, a first cleaning operation subroutine is started (step S48). The conditions for starting the subroutine includes the detection of the clogging sensor 31 reaching the threshold (YES in step S44) and the total usage time T of the air filter 11 exceeding the reference set time Ta (NO in step S44→YES in step S49). After the cleaning operation is completed in step S48, the cleaning flag Fb of the nonvolatile memory is set to 1 and the cleaning operation sequence ends (step S94→end). If the operation switch is turned OFF when these conditions are not satisfied, the cleaning flag Fb is set to 0. Thus, the control unit 33 makes a negative determination in step S47 and ends the cleaning operation sequence without performing the cleaning operation (NO in step S47→end).

In addition to advantages (1) to (3) of the first embodiment and advantages (5) to (7) of the fourth embodiment, the video projector of the seventh embodiment has the advantages described below.

(11) If the cleaning operation of the air filter 11 was performed when the previous projection operation ended, the cleaning operation of the air filter 11 is performed during a subsequent projection operation. In this case, a subtle amount of dust is scattered again into cooling air in the projector interior 5. This allows for the cleaning operation to be performed thoroughly (for example, the rotary brush 18 is moved leftward and rightward a number of times such as five times). This further reduces the amount of dust on the air filter 11 and prolongs the life of the air filter 11.

It should be apparent to those skilled in the art that the present invention may be embodied in many other specific forms without departing from the spirit or scope of the invention. Particularly, it should be understood that the present invention may be embodied in the following forms.

Although the first cleaning operation subroutine shown in FIG. 6 is performed in the fourth to seventh embodiments, the first cleaning operation subroutine may also be performed in the second operation subroutine shown in FIG. 9.

The cleaning means for the air filter is not restricted to the structure of each of the above embodiments. For example, the rotary brush 18 that removes dust from the air filter 11 may be moved in the leftward and rightward directions of the air filter device 10 without rotating. Further, the brush may be fixed and the air filter may be moved in the leftward and rightward directions.

Referring to the third and seventh embodiments, in a cleaning operation performed when a projection operation starts, the number of reciprocations in the leftward and rightward directions of the rotary brush 18 is set to a plural number of times as compared with the cleaning operation performed when the projection operation ends. However, the moving speed of the rotary brush 18 may be decreased in addition to increasing the number of the reciprocations of the rotary brush 18. This ensures dust removal.

In the fifth and sixth embodiments, a cleaning operation may be performed when a projection operation starts in the same manner as the seventh embodiment.

Although the intake fan 27 is arranged in the intake chamber 5a, the present invention is not restricted to such a structure. A duct may be connected to the intake chamber 5a to send ambient air, which passes through the air filter 11, to the liquid crystal light valves 24R, 24G, and 24B.

The intake fan 27, the lamp cooling fan 28, and the discharge fan 29 may be of any type, for example, a centrifugal fan, a propeller fan, or the like. Although the number of each of these fans is set to one in each of the embodiments, a plurality of each of these fans may be provided. For example, when there is a plurality of light source lamps 25, a lamp cooling fan may be provided for each light source lamp. Further, an intake fan may be provided for each of the liquid crystal light valve 24R for the red light, the liquid crystal light valve 24G for the green light, and the liquid crystal light valve 24B for the blue light.

In the fifth embodiment, the additional timer is used separately from the cumulative timer in order to measure the additional usage time ΔT. Instead, the additional usage time ΔT may be obtained without using the additional timer from the difference between the total usage time T measured by the cumulative timer and the reference set time Ta. This eliminates the need of the additional timer. In this case, in the cleaning operation sequence of FIG. 12, step S65 that starts operation of the actuation of the additional timer and step S69 that resets the additional timer are deleted.

The video projector is not limited to three-chip LCD projectors and may be a video projector that uses liquid crystal light valves. Further, the present invention may be applied to a projector that uses a reflective display element formed by a micromirror element referred to as a digital micromirror device (DMD).

The present examples and embodiments are to be considered as illustrative and not restrictive, and the invention is not to be limited to the details given herein, but may be modified within the scope and equivalence of the appended claims.

1. A video projector comprising:
an air inlet that draws in ambient air;
an air filter device including an air filter attached to the air inlet, wherein the air filter device performs a cleaning operation to remove dust from the air filter in accordance with a cleaning operation sequence;
an intake fan that draws in the ambient air through the air filter as cooling air for cooling a light valve;
a lamp cooling fan that sends interior air to a light source lamp as cooling air for cooling the light source lamp; and
a discharge fan that discharges the interior air that has cooled the light source lamp or the light valve,
wherein the cleaning operation sequence is configured to perform the cleaning operation during a cooling operation period in which the intake fan is stopped after a projection operation ends while the lamp cooling fan and the discharge fan are operating to cool the light source lamp.

2. The video projector according to claim 1, wherein the cleaning operation sequence is configured to perform the cleaning operation as long as a predetermined certain condition is satisfied when the projection operation ends.

3. The video projector according to claim 2, wherein the cleaning operation sequence is configured to perform the cleaning operation under the assumption that the certain condition is satisfied when a total usage time of the air filter from the cleaning operation performed on the air filter exceeds a predetermined reference set time as the projection operation ends or when clogging of the air filter is detected as the projection operation ends.

4. The video projector according to claim 3, wherein the cleaning operation sequence is further configured to perform the cleaning operation without waiting for the projection operation to end when the total usage time of the air filter from the cleaning operation performed on the air filter exceeds the predetermined reference set time during the projection operation and the projection operation is subsequently performed continuously for an additional usage time over a predetermined additional set time after the reference set time elapses.

5. The video projector according to claim 2, wherein the cleaning operation sequence is further configured to perform the cleaning operation without waiting for the projection operation to end when clogging of the air filter is detected during the projection operation.

6. The video projector according to claim 1, wherein the cleaning operation sequence is further configured to perform the cleaning operation, which removes dust from the air filter, while performing the projection operation when the projection operation starts after a previous projection operation ends and the cleaning operation is performed.

7. The video projector according to claim 2, wherein the cleaning operation sequence is further configured to perform the cleaning operation, which removes dust from the air filter, while performing the projection operation when the projection operation starts after a previous projection operation ends and the cleaning operation is performed.

8. The video projector according to claim 6, wherein the cleaning operation sequence is configured so that the cleaning operation performed during the projection operation takes a longer time than the cleaning operation performed when the projection operation ends.
